(19) United States
(12) Patent Application Publication
(10) Pub. No.: US 2018/0095328 A1
(43) Pub. Date: Apr. 5, 2018

(54) BACKLIGHT UNIT AND LCD DEVICE

(71) Applicant: Wuhan China Star Optoelectronics Technology Co., Ltd., Wuhan, Hubei (CN)

(72) Inventor: Gege ZHOU, Wuhan, Hubei (CN)

(73) Assignee: Wuhan China Star Optoelectronics Technology Co., Ltd., Wuhan, Hubei (CN)

(21) Appl. No.: 15/324,045

(22) PCT Filed: Oct. 12, 2016
(86) PCT No.: PCT/CN2016/101910

§ 371 Date: Jan. 5, 2017

(30) Foreign Application Priority Data
Apr. 28, 2016 (CN) 201610274063.5

(51) Int. Cl. G02F 1/1335; F21V 8/00

(52) U.S. Cl. CPC G02F 1/133602; G02B 6/0011

(57) ABSTRACT

The present disclosure provides a backlight unit, where the backlight unit includes: a backboard, a lateral light source, a light guide plate (LGP), and a plastic frame. The lateral light source provides a displaying light source. The LGP changes line light source of the lateral light source to surface light source, where the surface light source emits from a light outputting surface of the LGP. The backlight unit includes at least one accommodating structure arranged on a side of the lateral light source.

### BACKGROUND

### 1. Field of the Disclosure

The present disclosure relates to the field of backlights, and more particularly to a backlight unit and a liquid crystal display (LCD) device.

### 2. Description of the Prior Art

At present, liquid crystal display (LCD) devices, as a display component of electronic products, are widely used in different electronic products. Customers place greater demand for sizes of the electronic products, which requires placement of different electronic components of the electronic products to be rationalized. A backlight unit is one important unit of the LCD devices, and size of the backlight unit directly affects size of the LCD devices.

In general, shape of the backlight unit is similar to shape of a display panel of the LCD devices. A driving circuit of the display panel is arranged on a side of the display panel, and a lateral light source of the backlight unit is arranged on a side of the backlight unit, and the side of the display panel corresponds to the side of the backlight unit. Thus, non-display areas of left and right sides of display area of the display panel are asymmetrical.

In the above arrangement, as size of a conventional backlight unit is large, the size of the LCD devices is correspondingly large. Therefore, it is necessary to provide a backlight unit and an LCD device to solve the above issue of the prior art.

### SUMMARY OF THE DISCLOSURE

The aim of the present disclosure is to provide a backlight unit and a liquid crystal display (LCD) device having small sizes in order to solve the issue of a conventional backlight unit and the LCD device having large sizes.

The present disclosure provides the backlight unit, where the backlight unit comprises:

a backboard;

a light guide plate (LGP) arranged on the backboard; where a light incident surface of the LGP is corresponded to a light outputting surface of the lateral light source to change line light source of the lateral light source to surface light source and the surface light source emits from a light outputting surface of the LGP;

a plastic frame fixing the LGP and the lateral light source to the backboard;

a reflector plate arranged between the LGP and the backboard to reflect emitted light to the light outputting surface of the LGP; and

an optical film arranged on the light outputting surface of the LGP 113 to enhance the emitted light of the LGP;

The LGP is arranged on a projection position of the backboard that a display area of a liquid crystal display (LCD) panel projects on the backboard, and the lateral light source is arranged on a projection position of the backboard that a non-display area of the LCD panel projects on the backboard; the backlight unit comprises at least one accommodating structure arranged on a side of the lateral light source; the accommodating structure accommodates at least one of a control unit and a driving unit of the LCD device.

In the backlight unit of the present disclosure, the backlight unit comprises one accommodating structure, and the accommodating structure is arranged on a top portion or a bottom portion of a side of the lateral light source.

In the backlight unit of the present disclosure, the backlight unit comprises two accommodating structures, and the two accommodating structures are arranged on a top portion and a bottom portion of a side of the lateral light source.

In the backlight unit of the present disclosure, the optical film is adhered on the light outputting surface of the LGP with a double-sided adhesive tape.

In the backlight unit of the present disclosure, the backlight unit is adhered with the LCD panel by a double-sided adhesive tape, and the double-sided adhesive tape is an opaque adhesive tape.

The present disclosure further provides a backlight unit, where the backlight unit comprises:

a backboard;

a lateral light source arranged on the backboard to provide displaying light source;

a light guide plate (LGP) arranged on the backboard; wherein a light incident surface of the LGP is corresponded to a light outputting surface of the lateral light source to change line light source of the lateral light source to surface light source and the surface light source emits from a light outputting surface of the LGP; and

a plastic frame fixing the LGP and the lateral light source to the backboard.

The LGP is arranged on a projection position of the backboard that a display area of a liquid crystal display (LCD) panel projects on the backboard, and the lateral light source is arranged on a projection position of the backboard that a non-display area of the LCD panel projects on the backboard. The backlight unit comprises at least one accommodating structure arranged on a side of the lateral light source, and the accommodating structure accommodates at least one of a control unit and a driving unit of the LCD device.

In the backlight unit of the present disclosure, the backlight unit comprises the accommodating structure, and the accommodating structure arranged on a top portion or a bottom portion of the side of the lateral light source.

In the backlight unit of the present disclosure, the backlight unit comprises two accommodating structures, and the two accommodating structures are arranged on a top portion and a bottom portion of the side of the lateral light source.

In the backlight unit of the present disclosure, the backlight unit further comprises a reflector plate arranged between the LGP and the backboard to reflect emitted light to the light outputting surface of the LGP.

In the backlight unit of the present disclosure, the backlight unit further comprises an optical film arranged on the light outputting surface of the LGP to enhance the emitted light of the LGP.

In the backlight unit of the present disclosure, the optical film is adhered on the light outputting surface of the LGP with a double-sided adhesive tape.

In the backlight unit of the present disclosure, the backlight unit is adhered with the LCD panel by a double-sided adhesive tape, and the double-sided adhesive tape is an opaque adhesive tape.

The embodiment of the present disclosure further provide a liquid crystal display (LCD) device comprises a backlight unit and an LCD panel, where the backlight unit comprises:

a backboard;

a lateral light source arranged on the backboard to provide displaying light source;

a light guide plate (LGP) arranged on the backboard; wherein a light incident surface of the LGP is corresponded to a light outputting surface of the lateral light source to change line light source of the lateral light source to surface light source and the surface light source emits from a light outputting surface of the LGP; and

a plastic frame fixing the LGP and the lateral light source to the backboard.

The LGP is arranged on a projection position of the backboard that a display area of the LCD panel projects on the backboard, and the lateral light source is arranged on a projection position of the backboard that a non-display area of the LCD panel projects on the backboard. The backlight unit comprises at least one accommodating structure arranged on a side of the lateral light source; the accommodating structure accommodates at least one of a control unit and a driving unit of the LCD device

In the LCD device of the present disclosure, the backlight unit comprises one accommodating structure; the accommodating structure arranged on a top portion or a bottom portion of the side of the lateral light source.

In the LCD device of the present disclosure, the backlight unit comprises two accommodating structures; the two accommodating structures are arranged on a top portion and a bottom portion of the side of the lateral light source

In the LCD device of the present disclosure, the backlight unit further comprises a reflector plate arranged between the LGP and the backboard to reflect emitted light to the light outputting surface of the LGP.

In the LCD device of the present disclosure, the backlight unit further comprises an optical film arranged on the light outputting surface of the LGP to enhance the emitted light of the LGP.

In the LCD device of the present disclosure, the optical film is adhered on the light outputting surface of the LGP with a double-sided adhesive tape.

In the LCD device of the present disclosure, the backlight unit is adhered with the LCD panel by a double-sided adhesive tape, and the double-sided adhesive tape is an opaque adhesive tape

Compared to a conventional backlight unit and a conventional LCD device, the backlight unit and the LCD device of the present disclosure allow the accommodating structure to be arranged on the backboard, and add space to accommodate the control unit and the driving unit of the LCD device, which simultaneously reduces the size of the backlight unit and the LCD device based on the preferred first embodiment, further solving the issue that a conventional backlight unit and a conventional LCD device have large sizes.

### BRIEF DESCRIPTION OF THE DRAWINGS

FIG. 1 is an overview of a structural diagram according to a first embodiment of a liquid crystal display (LCD) device of the present disclosure.

FIG. 2 is a cross-sectional view according to the first embodiment of the

LCD device of the present disclosure.

FIG. 3 is an overview of a structural diagram according to a second embodiment of the LCD device of the present disclosure.

FIG. 4 is an overview of a structural diagram according to a third embodiment of the LCD device of the present disclosure.

### DETAILED DESCRIPTION

The following description of every embodiment with reference to the accompanying drawings is used to exemplify a specific embodiment, which may be carried out in the present invention. Directional terms mentioned in the present invention, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present invention. In the drawings, the components having similar structures are denoted by the same numerals.

In the drawings, a same reference number stands for a same element.

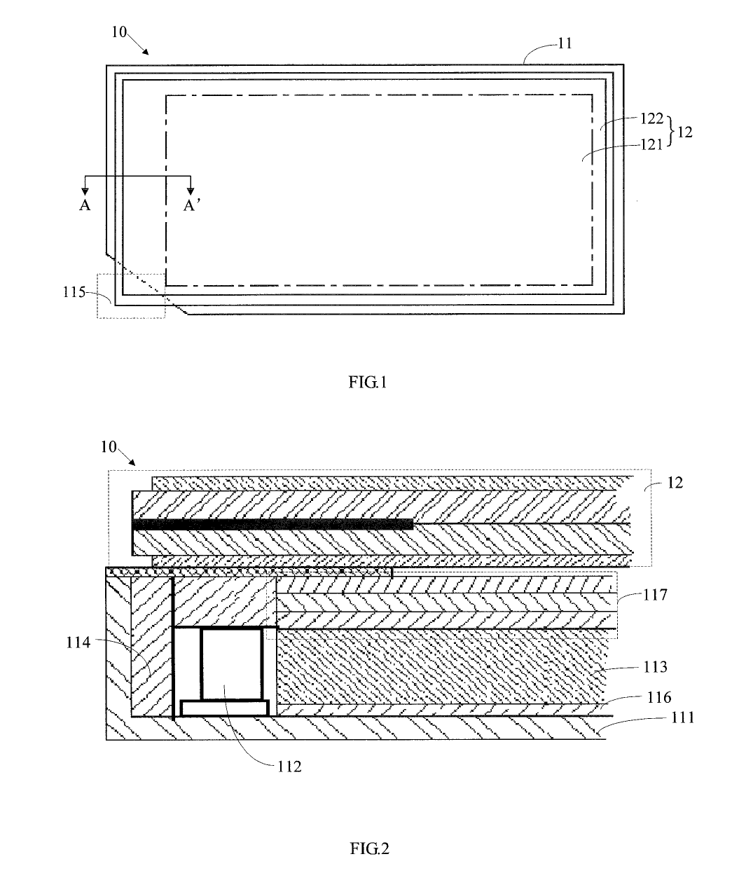

As shown in FIG. 1 and FIG. 2, FIG. 1 is an overview of a structural diagram according to a first embodiment of a liquid crystal display (LCD) device of the present disclosure, and FIG. 2 is a cross-sectional view along a sectional line A-A′ as shown in FIG. 1 according to the first embodiment of the LCD device of the present disclosure.

The LCD device 10 comprises a backlight unit 11 and an LCD panel 12, the backlight unit 11 comprises a backboard 111, a lateral light source 112, a light guide plate (LGP) 113, and a plastic frame 114. The lateral light source 112 is arranged on the backboard 111 as a light source. The LGP is arranged on the backboard 111, where a light incident surface of the LGP 113 corresponds to a light outputting surface of the lateral light source 112 to change a line light source of the lateral light source 112 to a surface light source. The surface light source emits from a light outputting surface of the LGP 113. The plastic frame 114 is used to fix the LGP 113 and the lateral light source 112 to the backboard 111.

The LGP 113 is arranged on where a display area 121 of the LCD panel 12 projects on the backboard 111, and the lateral light source 112 is arranged on where a non-display area 122 of the LCD panel 12 projects on the backboard 111. The backlight unit 11 comprises an accommodating structure 115 arranged on a bottom portion of a side of the lateral light source 112. The accommodating structure 115 is formed by chamfering a bottom portion of the side (width side of the non-display area 122) of the lateral light source 112. The accommodating structure 115 is used to accommodate at least one of a control unit and a driving unit of the LCD device 10. The control unit is regarded as a communication circuit or a control circuit of the LCD device 10, and the driving unit of the LCD device 10 is regarded as a driving circuit or a signal driving circuit.

Furthermore, the backlight unit 11 of the LCD device 10 of the preferred embodiment further comprises a reflector plate 116 and an optical film 117. The reflector plate 116 is arranged between the LGP 113 and the backboard 111 to reflect emitted light to the light outputting surface of the LGP 113. The optical film 117 is arranged on the light outputting surface of the LGP 113 to enhance the emitted light from the LGP 113.

Furthermore, the optical film 117 is adhered on the light outputting surface of the LGP 113 with a double-sided adhesive tape.

Furthermore, the backlight unit 11 is adhered with the LCD panel 12 by the double-sided adhesive tape, where the double-sided adhesive tape is an opaque adhesive tape.

When the LCD device 10 of the embodiment is used, the lateral light source 112 provides the display light source, where the display light source hits the light incident surface of the LGP 113, the LGP 113 changes the line light source of the lateral light source 112 to a surface light source, and the surface light source emits from the light outputting surface of the LGP 113. At the same time, the driving circuit of the LCD panel 12 drives pixel electrodes of the LCD panel 12 to adjust alignments of liquid crystal molecules of the liquid crystal layer, which allows the emitted light from the light outputting surface of the LGP 113 to pass through the liquid crystal layer to form light to display images.

The backlight unit 11 of the LCD device 10 of the preferred embodiment comprises the accommodating structure 115 arranged on the bottom portion of the side of the lateral light source 112. Thus, the control unit or the driving unit of the LCD device 10 can be accommodated on the accommodating structure 115, which reduces areas of a control unit region or a driving unit region of the LCD device 10, further reducing size of the LCD panel 12 as well as the LCD device 10.

The LCD device of the preferred embodiment allows the accommodating structure to be arranged on the backboard, and adds space to accommodate the control unit and the driving unit of the LCD device, which simultaneously reduces sizes of the backlight unit as well as the LCD device.

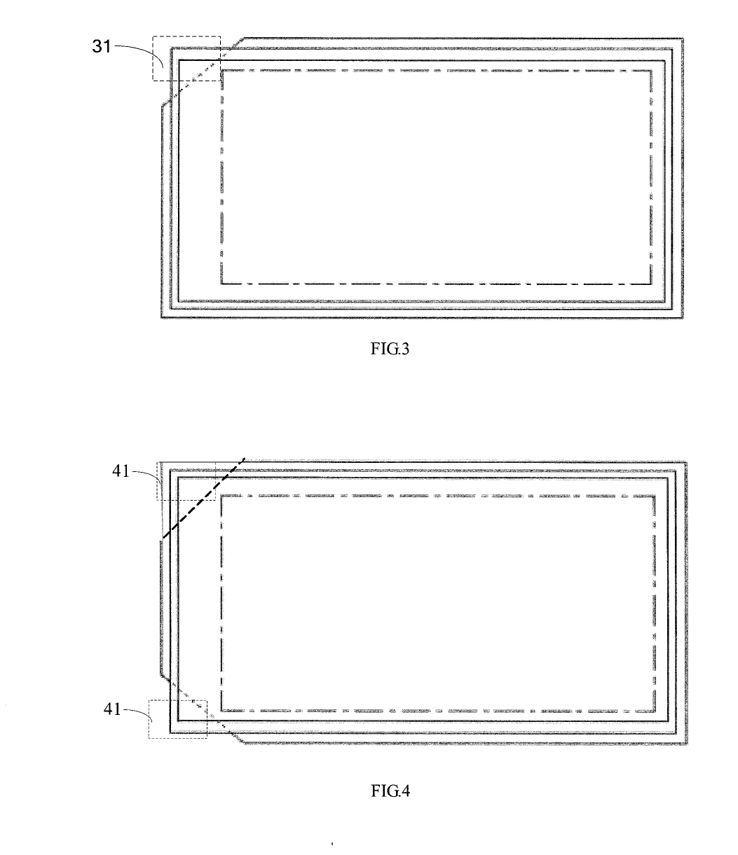

As shown in FIG. 3, FIG. 3 is an overview of a structural diagram according to a second embodiment of the LCD device of the present disclosure. Based on the preferred first embodiment, the backlight unit 11 of the LCD device 10 of the embodiment comprises an accommodating structure 31 arranged on a top portion of the side of the lateral light source. The accommodating structure 31 is used to accommodate at least one of the control unit and the driving unit of the LCD device 10.

Description of a specific operating principle of the LCD device of the embodiment is same as or similar with the above description of the specific operating principle of the LCD device of the preferred first embodiment. Please refer to the above description of the LCD device of the preferred first embodiment.

The LCD device of the embodiment also allows the accommodating structure to be arranged on the backboard, and provides space to accommodate the control unit and the driving unit of the LCD device, which simultaneously reduces the size of the backlight unit and the LCD device.

As shown in FIG. 4, FIG. 4 is an overview of a structural diagram according to a third embodiment of the LCD device of the present disclosure. Based on the preferred first embodiment, the backlight unit of the LCD device of the embodiment comprises accommodating structures 41 arranged on the top portion and the bottom portion of the side of the lateral light source 112. The accommodating structures 41 are used to accommodate at least one of the control unit and the driving unit of the LCD device 10.

Description of a specific operating principle of the LCD device of the embodiment is same as or similar with the above description of the specific operating principle of the LCD device of the preferred first embodiment. Please refer to the above description of the LCD device of the preferred first embodiment.

Two accommodating structures 41 are simultaneously arranged on the backboard of the LCD device of the embodiment, which further reduces sizes of the backlight unit and the LCD device based on the first embodiment.

The backlight unit and the LCD device of the present disclosure allow the accommodating structure to be arranged on the backboard, and provide space to accommodate the control unit and the driving unit of the LCD device, which simultaneously reduces sizes of the backlight unit and the LCD device based on the preferred first embodiment, further solving issues having large-sized conventional backlight units and conventional LCD devices.

As the above, it should be understood that the present disclosure has been described with reference to certain preferred and alternative embodiments which are intended to be exemplary only and do not limit the full scope of the present disclosure as set fourth in the appended claims.

What is claimed is:

1. A backlight unit, comprising:
a backboard;
a lateral light source, arranged on the backboard to provide a displaying light source;
a light guide plate (LGP) arranged on the backboard, wherein a light incident surface of the LGP corresponds to a light outputting surface of the lateral light source to change a line light source of the lateral light source to a surface light source, and wherein the surface light source emits from a light outputting surface of the LGP;
a plastic frame fixing the LGP and the lateral light source to the backboard;
a reflector plate arranged between the LGP and the backboard to reflect emitted light to the light outputting surface of the LGP; and
an optical film arranged on the light outputting surface of the LGP to enhance emitted light from the LGP;
wherein the LGP is arranged on a projection position of the backboard where a display area of a liquid crystal display (LCD) panel projects on the backboard, and the lateral light source is arranged on a projection position of the backboard where a non-display area of the LCD panel projects on the backboard; the backlight unit comprises at least one accommodating structure arranged on a side of the lateral light source; the accommodating structure accommodates at least one of a control unit and a driving unit of an LCD device.

2. The backlight unit as claimed in claim 1, wherein the backlight unit comprises one accommodating structure; the one accommodating structure is arranged on a top portion or a bottom portion of the side of the lateral light source.

3. The backlight unit as claimed in claim 1, wherein the backlight unit comprises two accommodating structures; the two accommodating structures are arranged on a top portion and a bottom portion of the side of the lateral light source.

4. The backlight unit as claimed in claim 1, wherein the optical film is adhered on the light outputting surface of the LGP with a double-sided adhesive tape.

5. The backlight unit as claimed in claim 1, wherein the backlight unit is adhered with the LCD panel by a double-sided adhesive tape, and the double-sided adhesive tape is an opaque adhesive tape.

6. A backlight unit, comprising:
a backboard;
a lateral light source arranged on the backboard to provide a displaying light source;
a light guide plate (LGP) arranged on the backboard; wherein a light incident surface of the LGP corresponds to a light outputting surface of the lateral light source to change a line light source of the lateral light source to a surface light source and wherein the surface light source emits from a light outputting surface of the LGP; and
a plastic frame fixing the LGP and the lateral light source to the backboard;
wherein the LGP is arranged on a projection position of the backboard where a display area of a liquid crystal display (LCD) panel projects on the backboard, and the lateral light source is arranged on a projection position of the backboard where a non-display area of the LCD panel projects on the backboard; the backlight unit comprises at least one accommodating structure arranged on a side of the lateral light source; the accommodating structure accommodates at least one of a control unit and a driving unit of an LCD device.

7. The backlight unit as claimed in claim 6, wherein the backlight unit comprises one accommodating structure; the one accommodating structure arranged on a top portion or a bottom portion of the side of the lateral light source.

8. The backlight unit as claimed in claim 6, wherein the backlight unit comprises two accommodating structures; the two accommodating structures are arranged on a top portion and a bottom portion of the side of the lateral light source.

9. The backlight unit as claimed in claim 6, wherein the backlight unit further comprises a reflector plate arranged between the LGP and the backboard to reflect emitted light to the light outputting surface of the LGP.

10. The backlight unit as claimed in claim 6, wherein the backlight unit further comprises an optical film arranged on the light outputting surface of the LGP to enhance emitted light from the LGP.

11. The backlight unit as claimed in claim 10, wherein the optical film is adhered on the light outputting surface of the LGP with a double-sided adhesive tape.

12. The backlight unit as claimed in claim 6, wherein the backlight unit is adhered with the LCD panel by a double-sided adhesive tape, and the double-sided adhesive tape is an opaque adhesive tape.

13. A liquid crystal display (LCD) device comprises a backlight unit and an LCD panel, wherein the backlight unit comprises:
a backboard;
a lateral light source arranged on the backboard to provide a displaying light source;
a light guide plate (LGP) arranged on the backboard; wherein a light incident surface of the LGP corresponds to a light outputting surface of the lateral light source to change line light source of the lateral light source to surface light source and the surface light source emits from a light outputting surface of the LGP; and
a plastic frame fixing the LGP and the lateral light source to the backboard;
wherein the LGP is arranged on a projection position of the backboard where a display area of the LCD panel projects on the backboard, and the lateral light source is arranged on a projection position of the backboard where a non-display area of the LCD panel projects on the backboard; the backlight unit comprises at least one accommodating structure arranged on a side of the lateral light source; the accommodating structure accommodates at least one of a control unit and a driving unit of the LCD device.

14. The LCD device as claimed in claim 13, wherein the backlight unit comprises one accommodating structure; the one accommodating structure arranged on a top portion or a bottom portion of the side of the lateral light source.

15. The LCD device as claimed in claim 13, wherein the backlight unit comprises two accommodating structures; the two accommodating structures are arranged on a top portion and a bottom portion of the side of the lateral light source.

16. The LCD device as claimed in claim 13, wherein the backlight unit further comprises a reflector plate arranged between the LGP and the backboard to reflect emitted light to the light outputting surface of the LGP.

17. The LCD device as claimed in claim 13, wherein the backlight unit further comprises an optical film arranged on the light outputting surface of the LGP to enhance emitted light of the LGP.

18. The LCD device as claimed in claim 17, wherein the optical film is adhered on the light outputting surface of the LGP with a double-sided adhesive tape.

19. The LCD device as claimed in claim 13, wherein the backlight unit is adhered with the LCD panel by a double-sided adhesive tape, and the double-sided adhesive tape is an opaque adhesive tape.
